(19) United States
(12) Patent Application Publication
(10) Pub. No.: US 2017/0120526 A1
(43) Pub. Date: May 4, 2017

(54) 3D Printing System and 3D Printing Control Method

(71) Applicant: Shenzhen Longer 3D Technology Co., Ltd., Shenzhen (CN)

(72) Inventors: Ganyang Zhang, Shenzhen (CN); Yang Shen, Shenzhen (CN); Jiajun Han, Shenzhen (CN)

(21) Appl. No.: 15/134,951

(22) Filed: Apr. 21, 2016

(30) Foreign Application Priority Data
Nov. 3, 2015 (CN) 201510738193.5

(51) Int. Cl. B29C 67/00; G05B 19/4099

(52) U.S. Cl. CPC B29C 67/0088; G05B 19/4099; B33Y 30/00

(57) ABSTRACT

A 3D printing system and a 3D printing control method are provided. The 3D printing system comprises: a main controller configured to identify a 3D printer and output a print file suitable for the 3D printer, the main controller comprising: a main control unit configured to identify the 3D printer, and generate the print file suitable for the 3D printer according to a three dimensional model; and a first wireless transmission unit; and a printing transmitter configured to communicate with the first wireless transmission unit and control the 3D printer to print, the printing transmitter comprising: a second wireless transmission unit connected to the main controller by wireless; a transmission control unit configured to control the 3D printer to print according to the print file; and a printing connection unit configured to be connected to the 3D printer.

### FIELD OF THE INVENTION

The present invention relates to 3D printing techniques, and particularly relates to a 3D printing system and a 3D printing control method.

### BACKGROUND OF THE INVENTION

The 3D printing technique is to print a three dimensional object in a layer by layer printing manner under control of the code generated by the host computer. The 3D printing technique has currently been applied to many fields such as the jewel, the shoe, the industrial design, the automobile and so on. In the 3D printing field, there are many kinds of printing technique types such as fused deposition type, light cure, selective laser sintering, and selective laser melting and so on.

Different printing technique types needs to be configured with the 3D printer with corresponding structures to implement the printing process. Meanwhile, even if in the 3D printers corresponding to the same printing technique type, the 3D printers of different model numbers remain difference in printing speed, size, and the range of accuracy and so on. Therefore, in the conventional 3D printing method, each special host computer software is only directed to a specific 3D printer to control the printing process. When a user needs to update the 3D printer or use different 3D printers due to different natures of the objects to be printed to perform the printing process, it all needs to design and install the respective host computer software to perform the printing process, which leads to increase in use cost and inconvenience for use.

### SUMMARY OF THE INVENTION

On the basis of this, it is necessary to provide a 3D printing system and a 3D printing control method, which can save cost, and is convenient for use by user.

A 3D printing system includes: a main controller configured to identify a 3D printer and output a print file suitable for the 3.D printer, the main controller includes: a main control unit configured to identify the 3D printer, and generate the print file suitable for the 3D printer according to a three dimensional model; and a first wireless transmission unit; and a printing transmitter configured to communicate with the first wireless transmission unit and control the 3D printer to print, the printing transmitter includes: a second wireless transmission unit connected to the main controller by wireless; a transmission control unit configured to control the 3D printer to print according to the print file; and a printing connection unit configured to be connected to the 3D printer.

In one of embodiments, related information of the 3D printer identified by the main control unit includes a printing technique type and a specific model number, and the main control unit generates the print file according to the printing technique type, the specific model number and the three dimensional model.

In one of embodiments, the main control unit is further configured to generate a support structure when determining the support structure is needed, and output the print file suitable for the 3D printer according to the support structure and the three dimensional model.

In one of embodiments, the main control unit is further configured to output a printing status detection instruction to detect whether a ready status of the 3D printer satisfies a printing condition or not, before the 3D printer starts printing.

In one of embodiments, the main control unit is further configured to output a printing status detection instruction to detect a printing status of the 3D printer in real time during a printing process of the 3D printer.

In one of embodiments, the transmission control unit is further configured to convert a format of the print file into a file type suitable for reception of the 3D printer.

In one of embodiments, the printing connection unit is configured to convert a format of the print file into a file type suitable for reception of the 3D printer.

In one of embodiments, the printing transmitter further includes a storage unit configured to store the print file; the storage unit is connected to the transmission control unit.

A 3D printing control method suitable for a 3D printing system, the 3D printing system includes: a main controller configured to identify a 3D printer and output a print file suitable for the 3D printer, the main controller includes: a main control unit configured to identify the 3D printer, and generate the print file suitable for the 3D printer according to a three dimensional model; and a first wireless transmission unit; and a printing transmitter configured to communicate with the first wireless transmission unit and control the 3D printer to print, the printing transmitter includes: a second wireless transmission unit connected to the main controller by wireless; a transmission control unit configured to control the 3D printer to print according to the print file; and a printing connection unit configured to be connected to the 3D printer; the print file comprises a plurality of printing task instruction sets, the method includes the following steps performed by the transmission control unit: receiving an instruction sent from the main controller by the second wireless transmission unit; determining a type of the instruction; if the instruction is a printing status detection instruction, then performing the following steps: transmitting the printing status detection instruction to the 3D printer by the printing connection unit; receiving a return information of the 3D printer; transmitting the return information to the main controller by the second wireless transmission unit; if the instruction is a printing task instruction, then performing the following steps: transmitting a printing task instruction set to the 3D printer by the printing connection unit; receiving a signal indicating the 3D printer has completed a printing process; determining whether transmission of the printing task instruction set is completed or not; if yes, stopping the transmission of the printing task instruction set; if not, continuously performing the transmission of the printing task instruction set.

In one of embodiments, the 3D printing control method further includes the following steps performed by the transmission control unit: transmitting a connection instruction to the main controller actively by the second wireless transmission unit; and determining whether the main controller is successfully connected; if yes, receiving an instruction sent from the main controller by the second wireless transmission unit; if not, continuously performing active transmission of the connection instruction.

The 3D printing system and the 3D printing control method described above has the following advantages: this 3D printing system and the 3D printing control method identify the 3D printer by the main control unit, output the print file suitable for the 3D printer according to a three dimensional model, and transmit the print file to the printing transmitter by the first wireless transmission unit. After the second wireless transmission unit in the printing transmitter receives the print file, the transmission control unit can control printing of the 3D printer according to the print file because the printing connection unit is connected to the 3D printer. Therefore, the 3D printing system and the 3D printing control method can be suitable for the 3D printers of different types, which overcomes the issue that in the conventional method, when a user needs to update the 3D printer or use different 3D printers due to different natures of the objects to be printed to perform the printing process, it all needs to design and install the respective host computer software to perform the printing process. The 3D printing system and the 3D printing control method of the invention can save cost, and is convenient for the user.

### BRIEF DESCRIPTION OF THE DRAWINGS

These and other features of the present invention will become readily apparent upon further review of the following specification and drawings. In the drawings, like reference numerals designate corresponding parts throughout the views. Moreover, components in the drawings are not necessarily drawn to scale, the emphasis instead being placed upon clearly illustrating the principles of the present disclosure.

FIG. 1 shows a schematic diagram of a 3D printing system in an embodiment;

FIG. 2 shows a flow chart of the method performed by the transmission control unit in the 3D printing system of the embodiment shown in FIG. 1.

### DETAILED DESCRIPTION OF THE EMBODIMENTS

For facilitating understanding of the present invention, the present invention will be described more fully hereinafter with reference to the related accompanying drawings. The better embodiments are given in the accompanying drawings. The invention may, however, be embodied in many different forms and should not be construed as limited to the embodiments set forth herein. Rather, the object for providing these embodiments is to understand this disclosure of the invention thoroughly and completely.

It will be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this invention belongs. Herein terms used in the specification of the invention aim at describing the specific embodiments without limiting the invention. Terms “and/or” used herein comprise any and all combination of one or more related item listed.

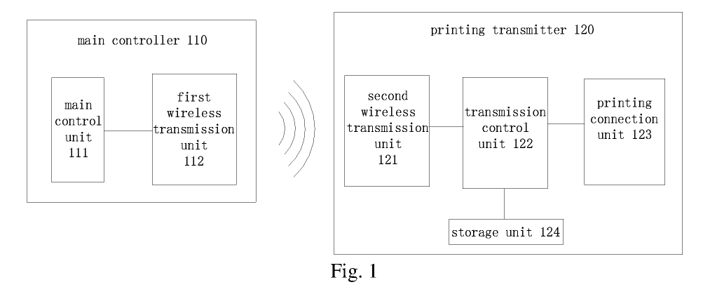

The following detailed description refers to the accompanying drawings that show, by way of illustration, specific details and aspects of this disclosure in which the invention may be practiced. FIG. 1 a schematic diagram of a 3D printing system in an embodiment.

As shown in FIG. 1, in an embodiment, the 3D printing system includes a main controller 110 and a printing transmitter 120. The main controller 110 and the printing transmitter 120 are connected by wireless. The printing transmitter 120 is connected to the 3D printer.

The main controller 110 includes a main control unit 111 and a first wireless transmission unit 112 connected with each other. The printing transmitter 120 includes a second wireless transmission unit 121, a transmission control unit 122, a printing connection unit 123 and a storage unit 124. The second wireless transmission unit 121, the transmission control unit 122 and the printing connection unit 123 are connected sequentially. The storage unit 124 is connected to the transmission control unit 122.

The main controller 110 is configured to identify the 3D printer and output the print file suitable for the 3D printer. In particular, the main controller 110 can be installed in an intelligent terminal, and then the main controller 110 can interact with the user. In this case, because the main controller 110 is connected to the printing transmitter 120 by wireless, the main controller 110 can indirectly communicate with the 3D printer by the printing transmitter 120 as long as the printing transmitter 120 is connected to the 3D printer.

The first wireless transmission unit 112 is connected to the printing transmitter 120 by wireless. In particular, the first wireless transmission unit 112 can perform transmission of data by Bluetooth or Radio Frequency.

The main control unit is configured to identify the 3D printer, and output the print file suitable for the 3D printer according to the three dimensional model. Because different 3D printers have different specific printing control manners, printing precision, printing parameters and the like, it needs to configure the matched print files for different 3D printers to perform the printing processes.

Therefore, the main control unit 111 in the embodiment firstly identifies the 3D printer. After related information of the 3D printer is identified, the printing design mode suitable for the 3D printer is set. In the printing design mode, related information matched with the 3D printer such as the set manners of each printing parameter and the printing control and the like is acquired, so that the main control. unit 111 can set the corresponding printing parameters, the control manner and the like for the three dimensional model to be printed in the printing design mode, and then generate the print file suitable for the 3D printer.

The main control unit 111 can identify the 3D printer by acquiring the characteristic parameters of the 3D printer. For example, after the printing transmitter 120 is connected to the 3D printer, related characteristic parameters of the 3D printer can be acquired directly, such as name of the 3D printer. Then, the main control unit 111 can receive the characteristic parameters acquired by the printing transmitter 120 by the first wireless transmission unit 112.

In another embodiment, the user can directly input the characteristic parameters related to the 3D printer by the human-computer interactive operating interface. At this time, the main control unit 111 can directly acquire the characteristic parameters of the 3D printer.

Particularly, the related information of the 3D printer identified by the main control unit 111 is the printing technique type and the specific model number. In this case, the main control unit 111 can set the corresponding printing design mode according to identified printing technique type and specific model number, and then in the printing design mode, the print file is output according to the three dimensional model.

Because different printing technique types have different printing manners and the set printing parameter classes in different printing manners are different, the main control unit firstly needs to identify the corresponding printing technique type of the 3D printer, such as fused deposition type, light cure, selective laser sintering, selective laser melting, for determining the corresponding printing parameter class.

Meanwhile, even if the 3D printer uses the same printing technique type, the printing size, the printing precision and the like required for the 3D printer are different because the natures of objects to be printed are different. Therefore, in the practical use, the 3D printers of the same printing technique type usually have different specific model numbers. On the basis of the above case, when the print file is designed by the main control unit 111, it needs to control other constraint conditions such as the set range of the printing parameters and the like for the specific model number of the 3D printer, to satisfy requirementsrequirement of different objects to be printed. Therefore, the main control unit 111 needs to identify the specific model number of the 3D printer.

After the main control unit 111 identifies the printing technique type and the specific model number, the main control unit 111 firstly generates the corresponding set mode of printing parameters according to the printing technique type. For example, for the printing technique type of fused deposition, the set mode of printing parameters about the hierarchical thickness, the printing wall thickness, the priming temperature, the printing speed, the filling ratio and the like is generated. For the printing technique type of light cure, the set mode of printing parameters about the hierarchical thickness, the printing speed, the filling ratio and the like is generated.

After the main control unit 111 generates the corresponding set mode of printing parameters according to the printing technique type, the main control unit 111 then sets other constraint conditions such as the adjusting range of each printing parameter and the like according to the specific model number. Finally, the main control unit 111 generates the design printing mode of the 3D printer.

It should be illustrated that the editing operation of the three dimensional model by the main control unit 111 comprises zooming in, zooming out, translating, and rotating the three dimensional model and so on, which facilitates performing the slice hierarchical process and enables to optimize the printing precision, for improving the printing quality. Then, in the generated printing design mode, the main control unit 111 generates the print file according to the edited three dimensional model.

Particularly, the main control unit 111 is further configured to generate a support structure when determining the support structure is needed, and output the print file suitable for the 3D printer according to the support structure and the three dimensional model. In an embodiment, the main control unit 111 determines whether the support structure is added or not according to the user requirement. For example, when the three dimensional model has a suspended structure of a small angle or is simple, the user can determine whether the support structure is added or not according to the practical case. Therefore, by the manner that the main control unit 111 determines whether the support structure is added or not according to the user requirement, different user requirements can be satisfied.

Further, when the main control unit 111 adds the support structure, the user can input set parameters of the support structure, such as the filling ratio, and then the main control unit 111 will add the corresponding support structure according to user input.

Particularly, the main control unit 111 is further configured to output the printing status detection instruction to detect whether the ready status of the 3D printer satisfies the printing condition or not, before the 3D printer starts printing. Therefore, the printing ready status of the 3D printer is detected, which ensures the 3D printer can satisfy the printing requirement and the printing quality is improved.

In an embodiment, the main control unit 111 transmits the above printing status detection instruction to the 3D printer by the printing transmitter 120, and acquires the status of the 3D printer by the printing transmitter 120. When the main control unit 111 finds the abnormal condition of the 3D printer, the user can be noticed by the manner that the abnormal information is displayed on the interactive operating interface.

Then, the printing parameters related to the status of the 3D printer are illustrated. For any printing technique type, the main control unit 111 needs to detect the printing material of the 3D printer until the printing material provided by the user satisfies the printing condition. For the printing technique type of selective laser melting, the main control unit 111 further detects whether the oxygen content, the moisture content and the inert gas pressure satisfy the printing condition or not until the oxygen content, the moisture content and the inert gas pressure satisfy the printing condition by removing oxygen from gas washing, removing moisture from gas washing and adjusting the pressure.

It should be noted that the function of detecting the status of the 3D printer before the. 3D printer starts printing can be performed by the 3D printer in the practical use. In this case, alter the 3D printer detects each parameter satisfies the printing condition, the instruction indicating, the status is normal will be directly transmitted to the main control unit 111 by the printing transmitter. At this time, because the print file is formed by a plurality of printing work instructions and has a larger capacity, the printing transmitter 120 can firstly store the print file into the storage unit 124.

Further, if the main controller 110 just transmits a part of printing work instructions in the print file to the 3D printer at a time, then a storage unit 124 can be not arranged in the printing transmitter 120, and the received printing work instructions are directly transmitted to the 3D printer at a time.

The transmission control unit 122 as a core control part of the printing transmitter 120 is configured to control the 3D printer to print according to the print file.

Particularly, the transmission control unit 122 is further configured to convert the format of the print file into the file type suitable for receiving by the 3D printer.

It should be illustrated that as long as one of the transmission control unit 122 and the printing connection unit 123 can perform the conversion function of the print file type, it is not limited to which specific unit perform this conversion function of the print file type.

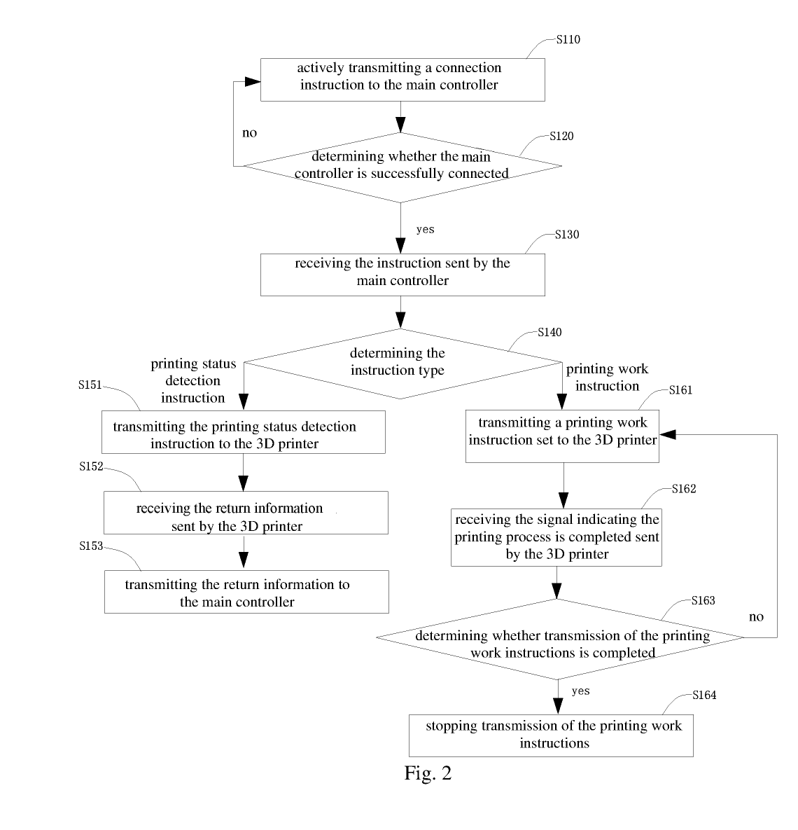

FIG. 2 shows a flow chart of the method performed by the transmission control unit 122 in the 3D printing system of an embodiment. The steps are as follows:

In step S110, the transmission control unit 122 actively transmits a connection instruction to the main controller 110 by the second wireless transmission unit 121.

In an embodiment, the transmission control unit 122 can regularly transmit the connection instruction to the main controller 110 by the second wireless transmission unit 121 by wireless. After the main controller 110 receives the connection instruction by the first wireless transmission unit 112, the main controller 110 will be connected to the printing transmitter 120 by wireless, and transmit a successful connection instruction to the printing transmitter 120.

In step S120, the transmission control unit 122 determines whether the main controller 110 is successfully connected or not; if yes, the step S130 is performed; if not, the step S110 is continuously performed.

In an embodiment, if the transmission control unit 122 receives the successful connection instruction by the second wireless transmission unit 121, then whether the main controller 110 is successfully connected or not is determined; if not, unsuccessful connection is determined.

It should be illustrated that other connection manner between the main controller 110 and the printing transmitter 120 can be used. For example, the main controller 110 regularly transmits a connection instruction to the printing transmitter 120, After the transmission control unit 122 receives the connection instruction by the second wireless transmission unit 121, the printing transmitter 120 is controlled to establish a wireless connection with the main controller 110, and transmits a successful connection instruction to the main controller 110.

In step S130, the transmission control unit 122 receives the instruction sent by the main controller 110 by the second wireless transmission unit 121.

It should be illustrated that on the one hand, the main controller 110 transmits the print file, to the 3D printer, and the print file is formed by a plurality of printing work instruction sets, the printing work instructions are configured to control each component of the 3D printer to perform the printing process according to a certain direction, speed and the like by driving of the driver motor. Generally, different printing work instruction sets sequentially perform the printing process in the order of time.

On the other hand, if the main controller 110 needs to detect the status of the 3D printer, the main controller 110 further transmits the printing status detection instruction to the 3D printer. The printing status detection instruction includes instructions indicating printing ready status such as feeding detection prior to the 3D printer performs the printing process, debugging detection of each component and the like. The printing status detection instruction further includes the printing status instruction such as detection of materials used during the printing process performed by the 3D printer, detection of the printing progress, detection of the printing temperature and the like.

It should be understood that in different cases, the instruction type sent by the main controller 110 is not limited to the above case. For example, the main controller only transmits the print file and does not transmit the printing status detection instruction to the 3D printer. At this time, status detection of the 3D printer is performed by other component.

In step S140, the transmission control unit 122 determines the instruction type. If the printing status detection instruction is determined, then the step S151 is performed; if the printing work instruction is determined, then the step S161 is performed.

It should be understood that if the main controller 110 only transmits the print file to the 3D printer, the transmission control unit 122 will not receive the printing status detection instruction sent by the main controller 110, and then in this case the transmission control unit 122 only needs to perform the step S161.

In step S151, the transmission control unit 122 transmits the printing status detection instruction to the 3D printer by the printing connection unit 123.

If the printing status detection instruction is the instruction indicating the printing ready status such as feeding detection before the 3D printer starts printing, debugging detection of each component and the like, then after the 3D printer receives the printing status detection instruction, the printing ready status of each component as a return information is transmitted back to the transmission control unit 122 by the printing connection unit 123.

If the printing status detection instruction is the printing status instruction such as detection of materials used during the printing process performed by the 3D printer, detection of the printing progress, detection of the printing temperature and the like, then after the 3D printer receives the printing status detection instruction, the real-time printing status such as materials used during the printing process, the printing progress, the printing temperature and the like as a return information is transmitted back to the transmission control unit 122 by the printing connection unit 123.

In step 5152, the transmission control unit 122 receives the return information sent by the 3D printer.

In step S153, the transmission control unit 122 transmits the above return information to the main controller 110 by the second wireless transmission unit 121 by wireless.

After the main controller 110 receives the return information, the control manner is adjusted in real time according to content of the return information. For example, the detected printing material feeding into the 3D printer prior to performing of the printing process does not satisfy the requirement, then the customer can be alerted by a certain manner, such as the alert information is displayed on the interactive interface. After a period of time, the main controller 110 again transmits the same printing status detection instruction to the 3D printer to detect whether the status of the 3D printer satisfies the printing condition or not; if yes, then the main controller 110 begins to transmit the print file to the 3D printer.

In step S161, the transmission control unit 122 transmits a printing work instruction set to the 3D printer by the printing connection unit 123.

After the 3D printer receives the printing work instruction set, the motor will be controlled to perform the corresponding movement for completing the corresponding printing process. After the 3D printer completes all steps of the printing work instruction set, the 3D printer will transmit a signal indicating the printing process is completed to the transmission control unit 122.

It should be understood that if in order to increase the printing speed the transmission control unit 122 will receive more numbers of printing work instructions at one time. then at this time the transmission control unit 122 may not transmit and store the printing work instructions to the storage unit 124 temporarily. When the transmission control unit 122 needs to transmit the stored printing work instructions to the 3D printer, the corresponding printing work instructions are acquired from the storage unit 124.

In step S162, the transmission control unit 122 receives the signal indicating the printing process is completed sent by the 3D printer by the printing connection unit 123.

In step S163, the transmission control unit 122 determines whether transmission of the printing work instructions is completed or not; if yes, transmission of the printing work instructions is stopped; if not, the step S161 is performed continuously.

It should be illustrated that if the main controller 110 transmits all of the printing work instructions in the print file to the printing transmitter one time, then after the transmission control unit 122 stops transmission of the printing work instructions, the 3D printer can complete all of printing operations.

If the main controller 110 transmits the print file to the 3D printer by many times, then only a part of the printing work instructions are transmitted to the 3D printer at a time. In this case, when the transmission control unit 122 stops transmission of the printing work instructions, the 3D printer just completes the printing operation corresponding to the received printing work instructions. After the main controller 110 continuously transmits other printing work instructions to the 3D printer at next time, the transmission control unit 122 will again transmit the respective printing work instructions to the 3D printer. The above process is repeated until the main controller 110 completes transmission of all of the printing work instructions in the print file.

To sum up, the 3D printing system and the 3D printing control method provided by the embodiment can identify the 3D printer by the main control unit, output the print file suitable for the corresponding 3D printer according to a three dimensional model, and transmit the print file to the printing transmitter 120 by the first wireless transmission unit 112. After the second wireless transmission unit 121 in the printing transmitter 120 receives the print file, the transmission control unit 122 can control printing of the 3D printer according to the print file because the printing connection unit 123 is connected to the 3D printer. Therefore, the 3D printing system can be suitable for the 3D printers of different types, which overcomes the issue that in the conventional method, when a user needs to update the 3D printer or use different 3D printers due to different natures of the objects to be printed to perform the printing process, it all needs to design and install the respective host computer software to perform the printing process. The 3D printing system and the 3D printing control method of the invention can save cost, and are convenient for the user.

Although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A 3D printing system, comprising:
a main controller configured to identify a 3D printer and output a print file suitable for the 3D printer, the main controller comprising:
a main control unit configured to identify the 3D printer, and generate the print file suitable for the 3D printer according to a three dimensional model; and
a first wireless transmission unit; and
a printing transmitter configured to communicate with the first wireless transmission unit and control the 3D printer to print, the printing transmitter comprising:
a second wireless transmission unit connected to the main controller by wireless;
a transmission control unit configured to control the 3D printer to print according to the print file; and
a printing connection unit configured to be connected to the 3D printer.

2. The 3D printing system of claim 1, wherein related information of the 3D printer identified by the main control unit comprises a printing technique type and a specific model number, and the main control unit generates the print file according to the printing technique type, the specific model number and the three dimensional model.

3. The 3D printing system of claim 1, wherein the main control unit is further configured to generate a support structure when determining the support structure is needed, and output the print file suitable for the 3D printer according to the support structure and the three dimensional model.

4. The 3D printing system of claim 1, wherein the main control unit is further configured to output a printing status detection instruction to detect whether a ready status of the 3D printer satisfies a printing condition or not, before the 3D printer starts printing.

5. The 3D printing system of claim 1, wherein the main control unit is further configured to output a printing status detection instruction to detect a printing status of the 3D primer in real time during a printing process of the 3D printer.

6. The 3D printing system of claim 1, wherein the transmission control unit is further configured to convert a format of the print file into a file type suitable for reception of the 3D printer.

7. The 3D printing system of claim 1, wherein the printing connection unit is configured to convert a format of the print file into a file type suitable for reception of the 3D printer.

8. The 3D printing system of claim 1, wherein the printing transmitter further comprises a storage unit configured to store the print file; the storage unit is connected to the transmission control unit.

9. A 3D printing control method for a 3D printing system, the 3D printing system comprising a main controller configured to identify a 3D printer and output a print file suitable for the 3D printer and comprising a main control unit and a first wireless transmission unit, the 3D printing system further comprising a printing transmitter configured to communicate with the first wireless transmission unit and control the 3D printer to print, the printing transmitter comprising a second wireless transmission unit, a transmission control unit, and a printing connection unit configured to be connected to the 3D printer, the method comprising:
receiving by the second wireless transmission unit an instruction sent from the main controller;
determining a type of the instruction;
in response to determining that the instruction is a printing status detection instruction:
transmitting the printing status detection instruction to the 3D printer by the printing connection unit;
receiving a return information of the 3D printer; and
transmitting by the second wireless transmission unit the return information to the main controller;
in response to determining that the instruction is a printing task instruction:
transmitting by the printing connection unit a printing task instruction set to the 3D printer;
receiving a signal indicating the 3D printer has completed a printing process;
determining either that the transmission of the printing task instruction set is completed and stopping the transmission of the printing task instruction set, or determining that the transmission of the printing task instruction is not completed and continuously performing the transmission of the printing task instruction set.

10. The method of claim 9, further comprising:
transmitting a connection instruction by the transmission control unit to the main controller actively by the second wireless transmission unit; and
determining either that the main controller is connected successfully and receiving an instruction sent from the main controller by the second wireless transmission unit, or determining that the main controller is not connected successfully and continuously performing active transmission of the connection instruction.
